(19) United States
(12) Patent Application Publication
(10) Pub. No.: US 2008/0016632 A1
(43) Pub. Date: Jan. 24, 2008

(54) Pushing Handle

(75) Inventor: Hermann HAAGA, Kirchheim/Teck (DE)

Correspondence Address: CROWELL & MORING LLP;INTELLECTUAL PROPERTY GROUP, P.O. BOX 14300, WASHINGTON, DC, 20044-4300, US

(73) Assignee: Ing. Haaga Werkzeugbau GmbH & Co. KG, Kirchheim/Teck (DE)

(21) Appl. No.: 11/779,671

(22) Filed: Jul. 18, 2007

(30) Foreign Application Priority Data
Jul. 20, 2006 (DE) 20 2006 011 450.5
Jun. 15, 2007 (DE) 10 2007 029 256.4

(51) Int. Cl. A46B 13/08; G05G 11/00

(52) U.S. Cl. 15/22.1; 74/488

(57) ABSTRACT

A pushing handle for a manually operated machine, in particular for a sweeping machine, with at least one machine-side connecting device, is provided, where the pushing handle is designed with a handle-side connecting device. The pushing handle is swivellably mountable on the machine-side connecting device of the machine by way of the handle-side connecting device, and the machine-side and the handle-side connecting devices are designed with a bush and an insertion pin corresponding to one another. Alternatively, a pushing handle is described having two handle-side connecting devices for mounting the handle to the machine at one height. A sweeping machine with a pushing handle of the described types is also provided.

### BACKGROUND AND SUMMARY OF THE INVENTION

This application claims the priorities of German Application Nos. 20 2006 011 450.5, filed Jul. 20, 2006 and 10 2007 029 256.4, filed filed Jun. 15, 2007, the disclosures of which are expressly incorporated by reference herein.

The invention relates to a pushing handle for a manually operated machine and, in particular, to a pushing handle for a sweeping machine.

A sweeping machine with a housing having a refuse collecting container is known from DE 196 17 986 A1, for example. The housing has in its front region two circular brooms that rotate inwards and in opposite directions about rotation axes positioned obliquely forward, and that inside the housing sweep across a sweeper plate that rises towards the refuse collecting container. A pushing handle is provided on the rear housing part for movement of the sweeping machine.

Pushing handles for manually operated machines are, wherever possible, attached to a machine such that the pushing handle is located at a suitable gripping height.

An object of the invention is to provide a pushing handle for a machine and, in particular, for a sweeping machine, by which an optimum gripping height can be set for various users. A further object is to provide a sweeping machine with a pushing handle of this type.

These and other objects are achieved in a pushing handle for a manually operated machine having at least one machine-side connecting device on the machine, where the pushing handle is designed with a handle-side connecting device such that the pushing handle is swivellably mountable on the machine-side connecting device of the machine by the handle-side connecting device. The machine-side and the handle-side connecting devices are designed with a bushing and an insertion pin, respectively, corresponding to one another. The busing and the insertion pin can be rotatable relative to one another, so that swiveling of the pushing handle is possible due to the insertion pin of the pushing handle being connected inside the busing of the machine. By swiveling the pushing handle, it is possible to set the latter to a suitable height.

A sweeping machine is also described that uses this type of pushing handle, in which the sweeping machine has at least one machine-side connecting device with a bushing as part of the connecting device. The sweeping machine further has a pushing handle that contains a handle-side connecting device that includes an insertion pin, wherein the bushing and the insertion pin correspond to one another such that the pushing handle is swivellably mounted on the machine-side connection device by use of the handle-side connecting device.

In a further development of the invention, the bushing and the insertion pin are conically shaped for providing a good transmission of force from the pushing handle to the machine.

In a further development of the invention, the pushing handle is designed with a bar that has a handle-side connecting device on at least one end and, in particular, a handle-side connecting device at both ends. The bar and the connecting device or the connecting devices are advantageously designed in several parts, where the bar is curved, for example from round stock, preferably a metal tube. The handle-side connecting devices are made in one embodiment of plastic, for example as injection moulded parts.

In a further development of the invention, the bar is at least partially elastically deformable. This ensures that the bushing and the insertion pin interact as a conical coupling, where the conical coupling can be released by deforming the bar, for example by bending it open, against the resisting force resulting from the elasticity of the bar, and the pushing handle is then swivellable without—or with little—friction resistance. The elasticity is achievable by, for example, bending of round stock into a bar. In other embodiments, separate springs can be provided by which the insertion pins are forced into the bushings.

In a further embodiment of the invention, the bushing and the insertion pin can be inserted without play into one another. The result is a good transmission of force.

In a further embodiment of the invention, the insertion pin and/or the corresponding bushing have at least one securing lug by which the insertion pin can be secured inside the bushing in the axial direction. In this embodiment, the insertion pin and the bushing are permanently engageable with one another by the securing lug.

In a further development of the invention, the bushing has at least one recess complementary to the at least one securing lug, so that the connection between the bushing and the insertion pin in an angular position is releasable in the axial direction. By swivelling the pushing handle, the securing lug and the recess can be arranged in alignment with one another so that the pushing handle can be disconnected by movement in the direction of the insertion or swivel axis.

In an embodiment of the invention, the pushing handle is engageable with the sweeping machine in at least one position. In one embodiment, the pushing handle is, for example, engageable with the sweeping machine in a parking position for stowage of the latter. The pushing handle and the sweeping machine have, in one embodiment, complementary engaging lugs and grooves for implementing this engagement.

According to another aspect of the invention a sweeping machine is provided with at least one machine-side connecting device and with a pushing handle, where the pushing handle is designed with a handle-side connecting device. The pushing handle is mounted swivellably on the machine-side connecting device of the sweeping machine, and the machine-side and the handle-side connecting devices are designed with a bushing and an insertion pin corresponding to one another. In one embodiment, the bushing and/or the insertion pin are designed as conically shaped. The machine-side connecting device is designed in one embodiment as a single piece with the sweeping machine. In another embodiment, the machine-side connecting device is made as a separate component connected to the sweeping machine.

In a further development of the invention, the machine-side connecting device is designed with a bushing. The sweeping machine has in one embodiment a housing made of plastic. The housing is designed with at least one bushing that is formed when the housing is moulded. A bushing of this type can therefore be made inexpensively. In another embodiment, the bushing is designed at least partially as a separate component that is connected to the housing. In a further embodiment, the bushing is coated to permit a good transmission of force.

In a further embodiment of the invention, a swivel axis of the bushing and a swivel axis of the insertion pin are so arranged that the distribution of force to drive wheels of the sweeping machine is optimized. The drive wheels are designed in one embodiment such that circular or disc-shaped brooms and/or cylinder brooms are driven by the drive wheels for sweeping.

In a further development of the invention, the swivel axis runs parallel to a rotation axis of the drive wheels and is arranged behind the rotation axis of the drive wheels when seen in the sweeping direction. An arrangement of this type permits a good distribution of force onto the drive wheels, in particular for driving circular brooms.

In another embodiment of the invention, the swivel axis runs parallel to a rotation axis of the drive wheels and is arranged in front of the rotation axis of the drive wheels when seen in the sweeping direction. An arrangement of this type permits a good distribution of force onto the drive wheels, in particular for driving cylinder brooms. In one embodiment of the invention, several machine-side connecting devices are provided, by which the pushing handle can be attached at different points.

In a further development of the invention, the swivel axis is arranged above the rotation axis of the drive wheels. This further improves the transmission of force.

In an embodiment of the invention, the sweeping machine has two machine-side connecting devices on opposite sides, wherein the pushing handle has two handle-side connecting devices corresponding to the machine-side connecting devices. This enables a secure connection to be achieved.

In a further development of the invention, the machine-side connecting devices are arranged symmetrically at one height. With this arrangement, the pushing handle can be attached to the sweeping machine reversed by 180°.

Further objects, advantages and novel features of the invention will become apparent from the following description of embodiments of the invention shown schematically in the drawings, wherein same reference numbers are used for identical components.

### BRIEF DESCRIPTION OF THE DRAWINGS

FIG. 1 is a side view of a sweeping machine with a pushing handle;

FIG. 2 is a partially cutaway front view of the sweeping machine according to FIG. 1;

FIG. 3 is a side view of the sweeping machine according to FIG. 2, where the pushing handle has been swivelled to a second position;

FIG. 4 is a schematic side view of the sweeping machine according to FIG. 1, where the pushing handle has been swivelled to a third position; and

FIG. 5 is a schematic side view of the sweeping machine according to FIG. 1, where the pushing handle has been attached reversed by 180°.

### DETAILED DESCRIPTION OF THE DRAWINGS

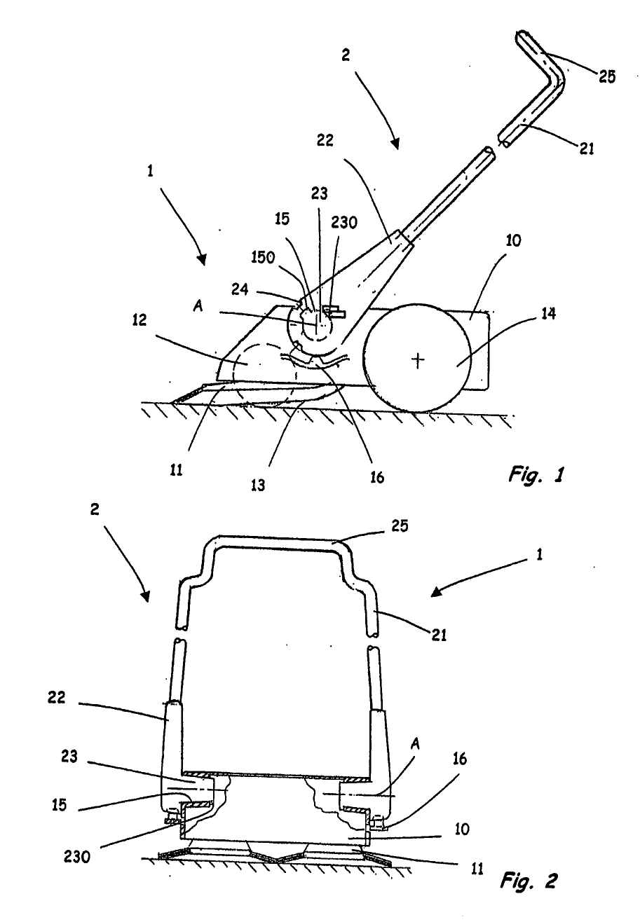

FIGS. 1 and 2 show in schematic form a side view and a partially cutaway front view of a sweeping machine 1 with a pushing handle 2. The sweeping machine 1 shown includes a housing 10 with a refuse collecting container. Two circular brooms 11 are attached inside the housing. The circular brooms 11 are, in the embodiment shown, each driven by a drive wheel 12 for rotation, only one of these being visible in FIG. 1. On account of the drive, the circular brooms 11 rotate about a rotation axis (not shown) which is tilted slightly forward. The rotating circular brooms 11 sweep across a schematically illustrated sweeper plate 13, through which refuse picked up between the circular brooms 11 is swept into the refuse collecting container. For improved running stability, the sweeping machine 1 shown furthermore has two running wheels 14, of which here too only one is visible in FIG. 1.

The sweeping machine 1 shown is a manually operated sweeping machine which can be moved, in particular pushed or pulled, by the pushing handle 2. The sweeping machine 1 and the pushing handle 2 have corresponding connecting devices by which they can be connected to one another in such a way that the pushing handle 2 is mounted swivellably about a swivel axis “A” on the housing 10 of the sweeping machine 1.

The pushing handle 2 includes, in the embodiment shown, a bar 21, on the ends of which two connecting devices 22 can be provided, with only one connecting device 22 being shown in FIG. 1.

For the swivellable connection of the pushing handle 2 to the sweeping machine 1, the connecting device 22 in the embodiment shown is designed with an insertion pin 23, which can be inserted free of play into a bushing 15 provided on the housing and corresponding to the insertion pin 23. As can be seen in FIG. 2, the bushing 15 and the insertion pins 23 are shaped conically, thereby achieving a good transmission of force from the pushing handle 2 to the housing 10 and hence to the drive wheels 12 mounted in the housing 10.

In the embodiment shown, the insertion pin 23 includes a securing lug 230, shown obscured in FIG. 2, which secures the insertion pin 23 inside the bushing 15 in the axial direction in the position shown in FIGS. 1 and 2. The pushing handle 2 is swivellable about the insertion or swivel axis “A” such that the securing lug 230 is aligned with a recess 150 provided on the bushing 15. In this position, not shown, of the pushing handle 2, the insertion pin 23 can be removed from the bushing 15 and hence the pushing handle 2 can be removed from the housing 10 of the sweeping machine 1.

The swivel axis “A” is arranged in the embodiment shown parallel to the rotation axes of the drive wheels 12 and the running wheels 14, and between them. The swivel axis “A” is positioned above a rotation axis of the drive wheels 12, thereby permitting a good transmission of force from the pushing handle 2 to the drive wheels 12.

In the embodiment shown, the connecting device 22 of the pushing handle 2 has, in addition, grooves 24 distributed over its periphery by which it can be engaged in various positions using engaging lugs 16 of the housing 10.

The bar 21 of the pushing handle 2 is designed in the embodiment shown with a holding part 25 angled at about 90° from bar 21 and permitting simple operation of the sweeping machine 1 (the 90° angle being shown in FIG. 1, but not in FIG. 2 for illustration purposes).

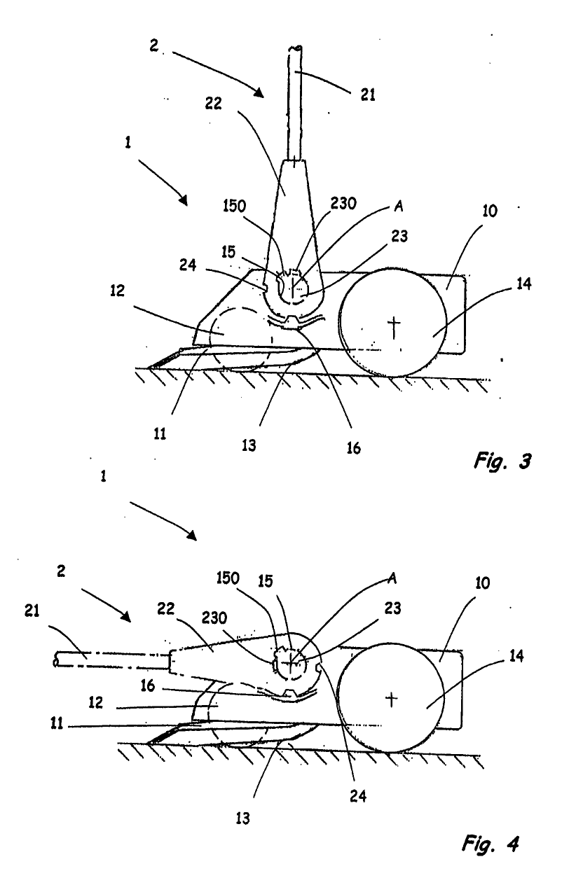

FIG. 3 shows in schematic form a side view of the sweeping machine 1 according to FIG. 1, where the pushing handle 2 is swivelled about the swivel axis “A” such that the bar 21 projects substantially vertically upwards. In this position, one of the grooves 24 of the handle-side connecting device 22 engages in the embodiment shown with the engaging lug 16 arranged on the housing 10. The pushing handle 2 can hence be engaged in the position shown in FIG. 3.

FIG. 4 is a further schematic illustration of the sweeping machine 1 according to FIG. 1, where the pushing handle 2 is swivelled into a third position. In the embodiment shown, the pushing handle 2 can be engaged with the housing 10 using the engaging lug 16 and a further groove 24. In the position shown in FIG. 4, the sweeping machine 1 can be stowed in a particularly simple and space-saving way.

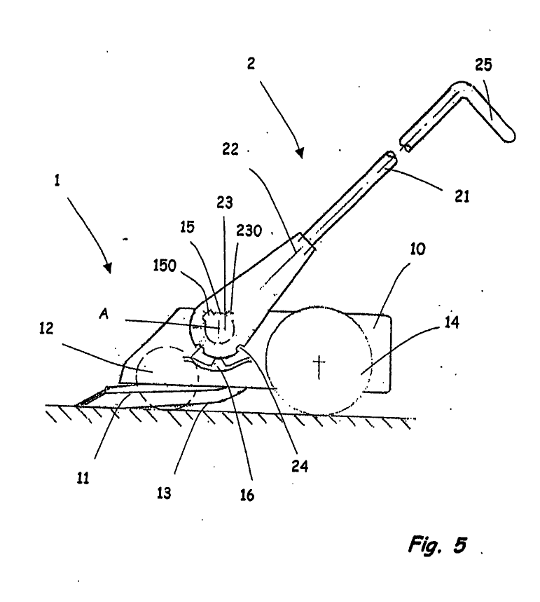

FIG. 5 shows the sweeping machine 1 according to FIG. 1, where the pushing handle 2 is attached to the housing 10 of the sweeping machine 1 in an attachment reversed by about 180°, so that the holding part 25 points downward as shown in FIG. 5.

The embodiments described using drawings show a sweeping machine with circular brooms as an example. The invention is, however, to be understood as not being restricted to sweeping machines of this type, and indeed, a pushing handle according to the invention is also advantageous for a cylinder broom sweeping machine or for other manually operated machines, for example a lawn-mower.

In the figures, the pushing handle is attached to machine-side connecting devices located behind the drive wheels. An arrangement of this type with the machine-side connecting devices is advantageous particularly for the sweeping machines shown with circular brooms. In other embodiments, connecting devices can be provided additionally and/or alternatively which are located in front of the rotation axis of the drive wheels and/or at the level of the rotation axis of the drive wheels. It is understood that while an exemplary description had the insertion pin on the handle-side connecting device, alternatively the insertion pin could be on the machine-side connecting device and the bushing be on the handle-side connecting device. It is furthermore contemplated that the pushing handle can be attached to a machine which has no drive wheels, but which can be moved on running wheels and has, for example, a powered sweeping device.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A pushing handle for a manually operated machine having at least one machine-side connecting device, where the pushing handle comprises:
a handle-side connecting device configured to swivellably mount on the at least one machine-side connecting device of the machine,
wherein the machine-side and the handle-side connecting devices comprise a bushing and an insertion pin, respectively, corresponding to one another.

2. The pushing handle according to claim 1, wherein the bushing and the insertion pin comprise a conical shape.

3. The pushing handle according to claim 1, further comprising a bar having two ends with the handle-side connecting device on at least one of said two ends.

4. The pushing handle according to claim 3, wherein the bar is at least partially elastically deformable.

5. The pushing handle according to claim 1, wherein the bushing and the insertion pin are insertable without play into one another.

6. The pushing handle according to claim 1, further comprising at least one securing lug configured to secure the insertion pin inside the bushing in an axial direction.

7. The pushing handle according to claim 6, wherein the bushing comprises at least one recess complementary to the at least one securing lug, so that a connection between the bushing and the insertion pin is in an angled position and is releasable in the axial direction.

8. The pushing handle according to claim 1, wherein the pushing handle is engageable with the machine in at least one position.

9. The pushing handle according to claim 3, wherein the pushing handle is mirror-symmetrical, and comprises two handle-side connecting devices arranged at one height on each of said two ends.

10. The pushing handle according to claim 1, wherein the machine is a sweeping machine.

11. A sweeping machine, comprising:
at least one machine-side connecting device comprising one of a bushing and an insertion pin; and
a pushing handle with a handle-side connecting device comprising the other one of the bushing and the insertion pin;
wherein the insertion pin and the bushing correspond to one another such that the pushing handle is swivellably mounted on the machine-side connecting device of the sweeping machine via the handle-side connecting device.

12. The sweeping machine according to claim 11, wherein the bushing and/or the insertion pin comprise a conical shape.

13. The sweeping machine according to claim 11, wherein the machine-side connecting device comprises a bushing.

14. The sweeping machine according to claim 11, further comprising drive wheels, wherein a swivel axis of the bushing and of the insertion pin is arranged for providing an optimized distribution of force to the drive wheels of the sweeping machine.

15. The sweeping machine according to claim 14, wherein the swivel axis runs parallel to a rotation axis of the drive wheels and is arranged behind the rotation axis of the drive wheels when seen in a sweeping direction.

16. The sweeping machine according to claim 14, wherein the swivel axis runs parallel to a rotation axis of the drive wheels and is arranged in front of the rotation axis of the drive wheels when seen in a sweeping direction.

17. The sweeping machine according to claim 14, wherein the swivel axis is arranged above a rotation axis of the drive wheels.

18. The sweeping machine according to claim 11, further comprising:
two machine-side connecting devices on opposite sides of a housing; and
two handle-side connecting devices on the pushing handle corresponding to the two machine-side connecting devices.

19. The sweeping machine according to claim 18, wherein the machine-side connecting devices are arranged symmetrically at one height.
